(19) United States
(12) Patent Application Publication
(10) Pub. No.: US 2023/0264439 A1
(43) Pub. Date: Aug. 24, 2023

(54) METHOD FOR MANUFACTURING A MECHANICAL PART, THE OBTAINED PART AND A CONTROL ARM

(71) Applicant: HUTCHINSON, PARIS (FR)

(72) Inventors: Guy VALEMBOIS, LAUZERVILLE (FR); Etienne BRETON, ESCALQUENS (FR)

(73) Assignee: HUTCHINSON, PARIS (FR)

(21) Appl. No.: 18/020,105

(22) PCT Filed: Aug. 10, 2021
(86) PCT No.: PCT/EP2021/072301

§ 371 Date: Feb. 7, 2023

(30) Foreign Application Priority Data
Aug. 12, 2020 (FR) FR2008467

(51) Int. Cl. B29C 70/68; B29C 70/70; B60G 7/00

(52) U.S. Cl. CPC B29C 70/682; B29C 70/683; B29C 70/70; B60G 7/001; B60G 2206/124; B60G 2206/7101; B60G 2206/8103; B60G 2206/8201

(57) ABSTRACT

A method for manufacturing a connection and/or transmission mechanical part disposed between two structures, which consists in carrying out the following successive operations:
making a rigid framework, through operations of shaping at least one rod or the like, in order to replicate the volume shapes of the part and create, at determined locations, segments with shapes suited to optimise the strength and the rigidity of the part,
incorporating into the framework at least one element suited to make an interface of the part with either one of the structures,
moulding a plastic matrix around the framework.

An object of the present invention is a method for manufacturing a connection and/or transmission mechanical part disposed between two structures, as well as the obtained part and a control arm.

In the field of mechanics, when two elements are movable relative to one another while being attached to one another, one suspended from the other for example, they are linked with one or more part(s) intended to make a connection, and possibly the transmission of a movement.

Such mechanical parts must have a given robustness and rigidity, and for this reason in most cases they are made of metal, by a casting or forging process.

Regardless of the considered mechanical field, without limitation, the automotive industry or the aeronautical industry, it is desired to lighten these mechanical parts, but while preserving rigidity.

One of the proposed solutions consists in using light and resistant alloys, such as titanium alloys, with the drawback of high costs which, depending on the destination of the parts, are prohibitive.

For mechanical parts that are not subjected to forces, or subjected to limited forces, it has been proposed to manufacture them in a composite material, namely they consist of a winding, preferably continuous, of reinforcing fibres embedded in a thermoformable or thermosetting matrix, said winding being adapted so that the fibres are disposed according to preferential orientations with regards to the directions of the tensile and/or compressive stresses.

While the gain in weight cannot be discussed, the resistance to stresses can nonetheless show limits, depending on the significance of these stresses.

On the other hand, the manufacture of these parts is sometimes difficult to automate, and often approaches craftsmanship, so that the manufacturing costs remain high.

It should be noted that there are already known methods for manufacturing parts, which combine an armature and a moulded plastic material, so as to obtain a lighter part.

Thus, the document EP 0 729 763 discloses a method for manufacturing a ski or the like, wherein longitudinal reinforcements are held in a mould by spacer parts before the injection of a polyurethane foam. This method allows obtaining a lightened ski while preserving rigidity and flexibility properties allowing for a controlled deformability, which is not the aim of the present application.

There are also known methods for manufacturing a reinforced wall, by moulding a plastic material over a mesh or the like, as disclosed for example in the document US 5 290 079. Nonetheless, such a wall is not suitable for the manufacture of a connection and/or transmission mechanical part.

The present invention aims to provide a method for manufacturing a connection and/or transmission mechanical part disposed between two structures, as well as the obtained part, whose weight is lower than that of similar parts made of metal, while having great strength and rigidity, and a reduced manufacturing cost, in particular thanks to automated manufacturing.

The method for manufacturing a connection and/or transmission mechanical part disposed between two structures according to the invention, is characterised in that it consists in carrying out the following successive operations:
making a rigid framework, through operations of shaping at least one rod or the like, in order to replicate the volume shapes of said part and create, at determined locations, segments with shapes suited to optimise the strength and the rigidity of said part,
incorporating into said framework at least one element suited to make an interface of said part with either one of said structures,
moulding a plastic matrix around said framework.

The at least one rod ensures the bending inertia, whereas the plastic matrix ensures the proper positioning of the rod(s). The matrix maintains the gap between the segments of the rod and/or of the rods, and blocks local buckling of the rod(s).

The rod may have different sections, it may also consist of a tube.

According to an additional feature of the method according to the invention, the at least one rod is metallic and shaping thereof is carried out by deformation.

According to another additional feature of the method according to the invention, the at least one rod is made of a composite material.

Preferably, yet without limitation, such a composite rod consists of unidirectional fibres embedded in a plastic matrix, and shaping thereof is carried out preferably, yet without limitation, by winding.

According to another additional feature of the method according to the invention, the plastic matrix is charged with reinforcing fibres.

According to another additional feature of the method according to the invention, the at least one element suitable for making an interface is incorporated by securing it to the framework.

According to another additional feature of the method according to the invention, the at least one element suitable for making an interface consists of a sleeve or a tube, which delimits an opening formed in the matrix.

According to another additional feature of the method according to the invention, before or after shaping the rod, the latter is subjected to a surface treatment operation adapted to make the latter rough.

According to another additional feature of the method according to the invention, transverse deformations are imparted on segments of the rod(s).

Making the surface of the rod rough and/or carrying out transverse deformations allow(s) creating areas of increased anchorage of the moulded plastic material.

From the manufacturing point of view, when the rod is metallic, the framework can be made automatically by means of a CNC wire bending machine, whereas the elements suited to make an interface of the part, could be welded to the rod after bending.

According to another additional feature of the method according to the invention, shapes suited to create secondary interfaces on the part are made during the moulding operation.

Another object of the present invention is a connection and/or transmission mechanical part disposed between two structures, characterised in that it includes a moulded plastic matrix, inside which a framework is embedded consisting of at least one rod shaped so as to match with the volume shape of said part, and some segments of which are disposed and oriented so as to optimise the strength and the rigidity of said part, and comprising at least one element suited to make an interface of said part with either one of said structures.

According to the invention, such a mechanical part is used as a control arm in the automotive industry and offers rigidity and strength comparable to those of existing metal control arms, while being lighter.

The advantages and features of the manufacturing process and of the part according to the invention will appear more clearly from the following description which relates to the appended drawing, which represents a non-limiting embodiment thereof.

In the appended drawing:

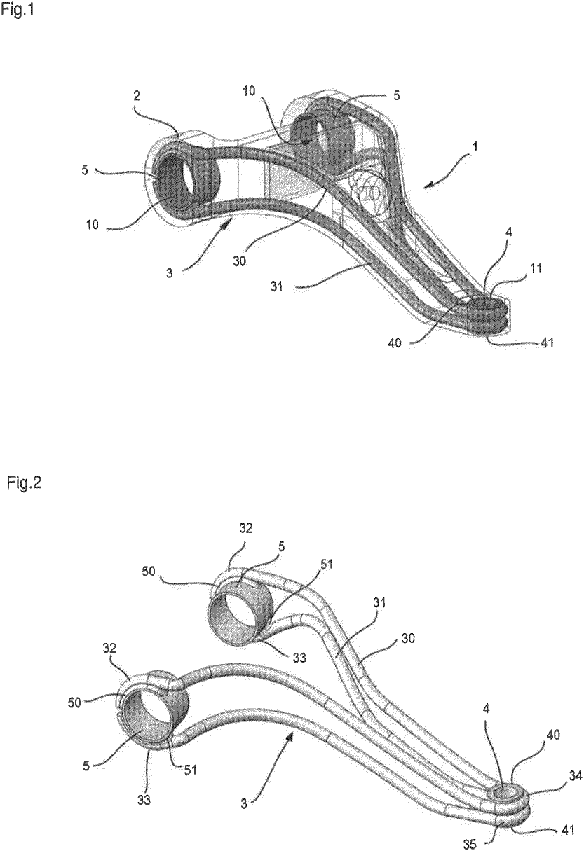

- FIG. 1 represents a schematic perspective view of a mechanical connection and/or transmission part obtained by the manufacturing method according to the invention,

- FIG. 2 represents a schematic perspective view of a portion of the same mechanical part,

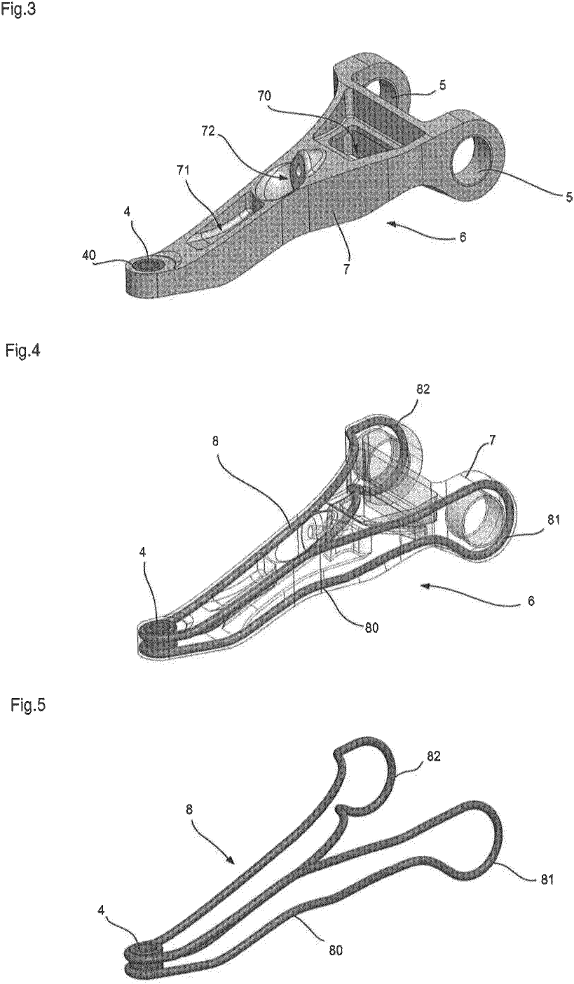

- FIG. 3 represents a schematic perspective view of a variant of the same mechanical part,

- FIG. 4 represents another schematic perspective view of the same mechanical part,

- FIG. 5 represents a schematic perspective view of a portion of the same mechanical part.

Referring to FIG. 1, one could see a mechanical part 1 according to the invention, made by the method according to the invention intended to link structures that are not represented, in this case it consists of a control arm of a motor vehicle, allowing linking a wheel to a chassis, and which is also an object of the present application.

This part 1, which is thus generally triangular in shape and has some thickness, comprises a plastic matrix 2 moulded over a framework 3, seen in transparency in this figure.

In FIG. 2, only the framework 3 is represented, which consists of two rods 30 and 31, in this case without limitation metallic and with a round section, shaped by bending to replicate the volume of the part 1. Thus, the metallic rods 30 and 31 are deployed in three dimensions to match with the shape of the part 1 in width, length and thickness.

The rods 30 and 31 are associated with elements suited to make interfaces of the part 1 with either one of the structures to be linked, and which consist of a tube 4 with collars 40 and 41, and two sleeves 5. In this particular embodiment, the sleeves 5 are distant and coaxial, whereas the tube 4 has an axis perpendicular to that of the sleeves 5.

As shown in FIG. 1, after the operation of moulding the plastic matrix, the sleeves 5 and the tube 4 delimit openings 10 and 11 respectively, adapted to receive connection means.

The rod 30 links the two sleeves 5 by passing around the tube 4 under the collar 40, whereas the rod 31 also links the two sleeves 5 passing around the tube 4 between the rod 30 and the collar 41, the two rods 30 and 31 being kept at a distance from one another, a distance which is variable, in accordance with the thickness of the part 1.

Advantageously, shaping of the rods is carried out on a CNC wire bending machine.

Each of the two end segments 32 of the rod 30 is secured to a sleeve 5, they are shaped as a circle arc and linked throughout a weld bead 50, whereas each of the two end segments 33 of the rod 31 is secured to a sleeve 5, they are shaped as a circle arc and linked throughout a weld bead 51.

Similarly, the rods 30 and 31 include at the tube 4 a segment, respectively 34 and 35, bent at 180°, to surround the tube 4 between the collars 40 and 41, securing being preferably completed with a weld.

The other segments of the framework 3 are either straight or curved, and in orientations selected so as to provide the framework 3 and therefore the part 1 with optimum compressive and/or tensile strength, when the part 1 undergoes loads to which it should be submitted.

The plastic matrix 2, moulded over the framework 3, allows fixing the latter in its most accomplished configuration. The gaps between the rods 30 and 31, or between the different portions of the framework 3 are maintained even when the part 1 is loaded.

Advantageously, the rods 30 and 31 are, totally or partially and before the moulding operation, subjected to a surface treatment allowing making them rough, so as to reinforce connection with the plastic matrix 2 and thus limit and even eliminate the risks of relative movements.

For the same purpose, the surface treatment may be replaced or supplemented, by creating on the rods 30 and 31 at least loaded locations, transverse deformations such as bosses or the like allowing for an enhanced anchorage.

The formation of the bosses or the like is carried out during shaping of the rods 30 and 31, by means the CNC wire bending machine.

Referring now to FIGS. 3, 4 and 5, one could see a variant of the method according to the invention, for making a part 6. It also includes a moulded plastic matrix 7, as well as a framework 8, visible in FIGS. 4 and 5, which is obtained by the deformation of a single rod 80, deformed and shaped as a closed loop, the two ends, not visible, being butt joined and welded.

The part 6 also includes elements suited to make interfaces with either one of the structures to be linked, and which herein again consist of a tube 4 and two sleeves 5, with the difference for these that they are not secured to the framework 8.

Thus, the rod 80 is bent to replicate the volume of the part 6. In particular, it forms two coaxial loops 81 and 82, each intended to remotely surround a sleeve 5 subsequently held by the plastic matrix 7.

It should be noted, as shown in particular in FIG. 3, that the matrix 7 does not fill the entire volume defined by the framework 8, but that there remain voids 70 or recesses 71, which do not contribute to the resistance of the part 6, and which allow lightening the part 6.

In the same manner, moulding of the matrix 7 allows shaping the surface of the part 6, for example to form an interface 72 for fastening an accessory which is not involved in loading of the part 6.

1. A method for manufacturing a connection and/or transmission mechanical part disposed between two structures, characterised in that it consists in carrying out the following successive operations:
making a rigid framework, through operations of shaping at least one rod or the like, in order to replicate the volume shapes of said part and create, at determined locations, segments with shapes suited to optimise the strength and the rigidity of said part,
incorporating into said framework at least one element suited to make an interface of said part with either one of said structures,
moulding a plastic matrix around said framework.

2. The manufacturing method according to claim 1, characterised in that the at least one rod is metallic and shaping thereof is carried out by deformation.

3. The manufacturing method according to claim 1, characterised in that the at least one rod is made of a composite material.

4. The manufacturing method according to claims 1, characterised in that the plastic matrix is charged with reinforcing fibres.

5. The manufacturing method according to claims 1, characterised in that the at least one element suitable for making an interface is incorporated by securing it to the framework.

6. The manufacturing method according to claims 1, characterised in that the at least one element suitable for making an interface consists of a sleeve or a tube, which delimits an opening formed in the matrix.

7. The manufacturing method according to claims 1, characterised in that, before or after shaping the rod, the latter is subjected to a surface treatment operation adapted to make the latter rough.

8. The manufacturing method according to claims 1, characterised in that transverse deformations are imparted on segments of the rod(s).

9. The manufacturing method according to claims 1, characterised in that shapes suited to create secondary interfaces on the part are made during the moulding operation.

10. A connection and/or transmission mechanical part disposed between two structures, characterised in that it includes a moulded plastic matrix, inside which a framework is embedded consisting of at least one rod shaped so as to match with the volume shape of said part, some segments of which are disposed and oriented so as to optimise the strength and the rigidity of said part, and comprising at least one element suited to make an interface of said part with either one of said structures.

11. A control arm, characterised in that it consists of a part according to claim 10.
